(19) United States
(12) Patent Application Publication
(10) Pub. No.: US 2006/0061280 A1
(43) Pub. Date: Mar. 23, 2006

(54) Plasma display panel including plasma pipe

(76) Inventors: Jeong Pil Choi, Suwon-si (KR); Sung Chun Choi, Anyang-si (KR)

Correspondence Address: MCKENNA LONG & ALDRIDGE LLP;Song K. Jung, 1900 K Street, N.W., Washington, DC, 20006, US

(21) Appl. No.: 11/230,481

(22) Filed: Sep. 21, 2005

(30) Foreign Application Priority Data
Sep. 21, 2004 (KR) 10-2004-0075691

(51) Int. Cl. H01J 17/49

(52) U.S. Cl. 313/582

(57) ABSTRACT

The present invention relates to a plasma display panel, more particularly to a plasma display panel including a plasma pipe. A plasma display panel according to the present invention comprises a plurality of polygonal plasma pipes having a fluorescent substance inside; a first electrode disposed in the perpendicular direction of the plasma pipes; and a second electrode disposed in the perpendicular direction of the first electrode and disposed in the horizontal direction of the plasma pipes. The present invention is able to lower a firing voltage and to decrease a power consumption by enlarging the overlapping area with electrodes through including a polygonal plasma pipe.

This Nonprovisional application claims priority under 35 U.S.C. § 119(a) on Patent Application No. 10-2004-0075691 filed in Korea on Sep. 21, 2004, the entire contents of which are hereby incorporated by reference.

### BACKGROUND OF THE INVENTION

1. Field of the Invention

The present invention relates to a plasma display panel, more particularly to a plasma display panel including a plasma pipe.

2. Description of the Background Art

Generally, in a plasma display panel, barrier ribs formed between a front substrate and a rear substrate form unit or discharge cells. Each of the cells is filled with an inert gas, such as a mixture of He and Xe, or a mixture of He and Ne. When a high frequency voltage discharges the inert gas, the inert gas generates vacuum ultraviolet rays, which thereby cause fluorescent substance to emit light, thus displaying an image.

FIG. 1 is a perspective view illustrating the configuration of a conventional plasma display panel. As shown in FIG. 1, the plasma display panel includes a front glass substrate 10 displaying an image and a rear glass substrate 20. The front glass substrate 10 and the rear glass substrate 20 are disposed parallel to each other with a gap in-between.

The front glass substrate 10 includes a sustain electrode 11, 12 formed in pairs for maintaining the light emission of a cell by mutual discharge. The sustain electrodes 11, 12 includes a transparent electrode 11a, 12a made of a transparent ITO material and a bus electrode 11b, 12b made of a metal material.

The sustain electrode 11, 12 is covered with an upper dielectric layer 13a. The upper dielectric layer 13a forms wall charges and protects electrodes from an ion impact during plasma discharge. A protection layer 14 made of magnesium oxide MgO is formed on top of the upper dielectric layer 13a, making it easier to emit secondary electrons.

A plurality of address electrodes 22 are formed on the rear glass substrate 20 and arranged in parallel with barrier ribs 21 for performing discharges in the region where address electrodes intersect with the sustain electrode 11, 12.

A lower dielectric layer 13b is formed on top of the address electrodes 22. A plurality of discharge space or barrier ribs 21 for forming cells are arranged on the lower dielectric layer 13b. R, G, B fluorescent layer 23 for emitting visible rays for displaying images is coated between barrier ribs 21.

The operating principle of a conventional plasma display panel having the structure described above will be explained in detail. Writing discharges are performed when a firing voltage is applied to one electrode of sustain electrodes 11, 12 in a pair and an address signal is applied to address electrodes 22.

In other words, an electric field is generated inside of the cell to accelerate a small amount of electrons in a discharge gas. The accelerated electron collides with a neutron particle in the gas to ionize into an electron and an ion. The ionized electron collides with another neutron particle to ionize the neutron particle into another electron and another ion with a more accelerated speed. As a result, the discharge gas transforms into a plasma state and vacuum ultra-violet rays are generated due to a surface discharge on the surface of the upper dielectric layer 13a and the protection layer 14.

The vacuum ultra-violet rays excite a fuorescent layer 23 surrounding barrier ribs to generate visible rays. Visible rays are emitted through the front glass substrate to display colours corresponding R, G, B.

The conventional plasma display technology described above limits the size of the plasma display panel can be. For example, a glass substrate needs to be over 100 inches, it is very difficult to fabricate a glass substrate over 100 inches using the conventional technology.

FIG. 2a and FIG. 2b represent the configuration of a plasma display panel including a conventional plasma pipe. As shown in FIG. 2a, plasma pipes 210a, 210b, 210c surrounding R,G,B fluorescent substance are inserted into between a first panel 240 where a sustain electrode is formed and a second panel 245 where an address electrode is formed. It is possible to fabricate plasma pipes 210a, 210b, 210c having a diameter of approximately 1 mm, with lengthes ranging from 1 m to 3 m.

As shown in FIG. 2b, the plasma pipe 210 surrounds R,G,B fluorescent substance 230. An inert gas, such as He—Xe, or He—Ne is inserted inside of the plasma pipe 210, where a protection layer made of magnesium oxide MgO is formed. A sustain electrode 250 maintaining discharges by a discharge sustaining voltage and an address electrode 270 generating address discharges are in contact with the plasma pipe 210. Vacuum ultraviolet rays generated by the sustain electrode 250 and the address electrode 270 excite the R,G,B fluorescent substance 230 surrounded by the plasma pipe 210 so that the R,G,B fluorescent substance 230 emits a light.

However, as shown in FIG. 2a, the plasma pipe 210 has a cylinder shape so that the overlapping area between the plasma pipe 210 and the sustain electrode 250 or address electrode 270 is small. Accordingly, the firing voltage needed increases and power consumption increases. In addition, it is difficult to connect plasma pipes 210 to each other as the contact area between plasma pipes 210 becomes smaller, when plasma pipe 210 is arranged with an adjacent plasma pipe.

As shown in FIG. 2b, the plasma pipes 210a, 210b, 210c surrounding the fluorescent substance 230 are the same size so that a color temperature will be too low because of the blue fluorescent substance 230c having a low light emitting efficiency.

### SUMMARY OF THE INVENTION

Accordingly, an object of the present invention is to solve at least the problems and disadvantages of the background art.

The object of the present invention is to provide a plasma display panel including a plasma pipe capable of enlarging the overlapping area between the plasma pipes and electrodes.

Another object of the present invention is to provide a plasma display panel capable of enlarging the overlapping area between adjacent plasma pipes.

Still another object of the present invention is to improve the color temperature of a plasma display panel including a plasma pipe.

A plasma display panel according to the present invention comprises a plurality of polygonal plasma pipes having a fluorescent substance inside; a first electrode disposed in the perpendicular direction of the plasma pipes; and a second electrode disposed in the perpendicular direction of the first electrode and disposed in the horizontal direction of the plasma pipes.

A plasma display panel according to the present invention comprises a plurality of polygonal plasma pipes having different magnitudes according to the kind of a fluorescent substance formed inside of the plasma pipes; a first electrode disposed in the perpendicular direction of the plasma pipes; and a second electrode disposed in the perpendicular direction of the first electrode and disposed in the horizontal direction of the plasma pipes.

A plasma display panel according to the present invention comprises a first polygonal plasma pipe of which fluorescent substance B is formed inside; a second polygonal plasma pipe having a smaller magnitude than the magnitude of the first polygonal plasma pipe, while a fluorescent substance different with the fluorescent substance B is formed inside of the second polygonal plasma pipe; a first electrode disposed in the perpendicular direction of the first plasma pipe and the second plasma pipe; and a second electrode disposed in the perpendicular direction of the first electrode and disposed in the horizontal direction of the second plasma pipe.

The present invention lowers the firing voltage and decreases the power consumption by enlarging the overlapping area between the plasma pipes and electrodes by including a polygonal plasma pipe.

The present invention is able to provide a easy connection between plasma pipes by including a polygonal plasma pipe.

The present invention optimizes color temperature by altering the amount of fluorescent substance formed within a polygonal plasma pipe.

The present invention optimizes a color temperature by forming a fluorescent substance within the plasma pipes having different magnitudes.

### BRIEF DESCRIPTION OF THE DRAWINGS

The invention will be described in detail with reference to the following drawings in which like numerals refer to like elements.

FIG. 1 is a perspective view illustrating the configuration of a conventional plasma display panel.

FIG. 2a and FIG. 2b represent the configuration of a plasma display panel including a conventional plasma pipe.

FIG. 3 represents the configuration of a plasma display panel according to the present invention.

FIG. 4 represents a plasma display panel including a plasma pipe according to the present invention.

FIG. 5 represents an embodiment of a plasma pipe having a fluorescent substance of the present invention.

FIG. 6 represents another embodiment of a plasma pipe having a fluorescent substance of the present invention.

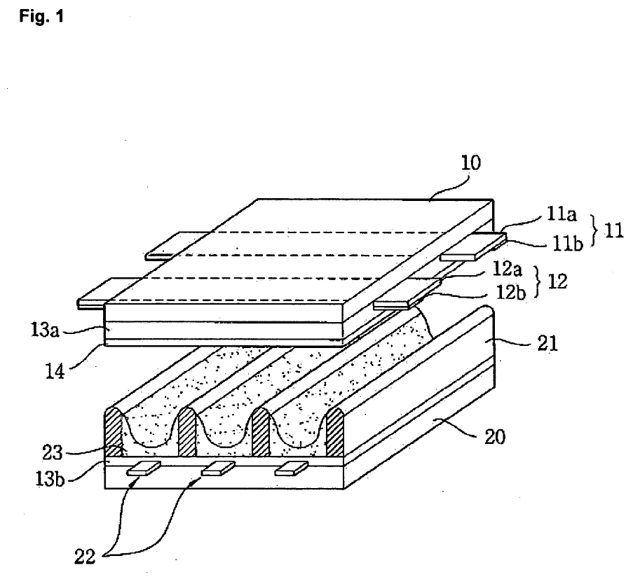

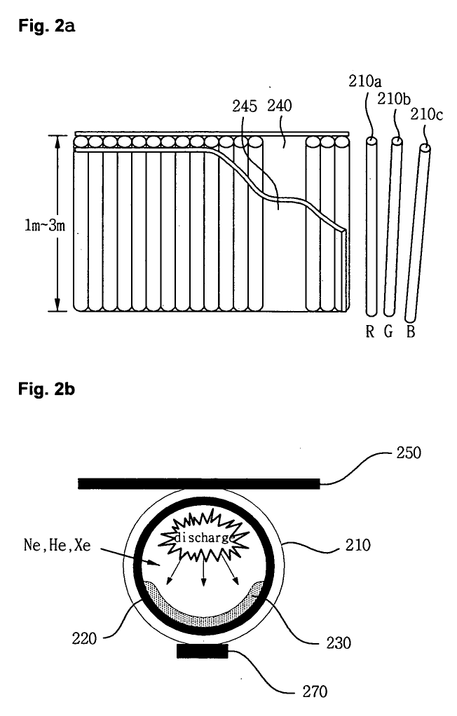

### DETAILED DESCRIPTION OF PREFERRED EMBODIMENTS

Preferred embodiments of the present invention will be described in a more detailed manner with reference to the drawings.

A plasma display panel according to the present invention comprises a plurality of polygonal plasma pipes having a fluorescent substance inside; a first electrode disposed in the perpendicular direction of the plasma pipes; and a second electrode disposed in the perpendicular direction of the first electrode and disposed in the horizontal direction of the plasma pipes.

The polygonal plasma pipe is a rectangular plasma pipe.

The plurality of polygonal plasma pipes are coupled to each other by a surface contact.

Each of the plurality of polygonal plasma pipes has the same magnitude, while the amount of fluorescent substance formed in some polygonal plasma pipes among the plurality of polygonal plasma pipes is greater than the amount of fluorescent substance substance formed in the other polygonal plasma pipes.

The fluorescent substance formed in some polygonal plasma pipes of the plurality of polygonal plasma pipes is fluorescent substance B.

Some polygonal plasma pipes among the plurality of polygonal plasma pipes are larger than the other polygonal plasma pipes.

The amount of fluorescent substance formed inside of the some polygonal plasma pipes is greater than the amount of fluorescent substance substance formed inside of the other polygonal plasma pipes.

The fluorescent substance formed in the some of the polygonal plasma pipes is blue fluorescent substance.

A plasma display panel according to the present invention comprises a plurality of polygonal plasma pipes having different magnitudes according to the kind of a fluorescent substance formed inside of the plasma pipes, a first electrode disposed in the perpendicular direction of the plasma pipes; and a second electrode disposed in the perpendicular direction of the first electrode and disposed in the horizontal direction of the plasma pipes.

The width of some plasma pipes among the plurality of polygonal plasma pipes is greater than the width of the other plasma pipes.

Some polygonal plasma pipes of which the blue fluorescent substance is formed inside among the plurality of polygonal plasma pipes is larger than the other plasma pipes.

The width of the some plasma pipes of which fluorescent substance B is formed inside is greater than the width of the other plasma pipes.

The plurality of polygonal plasma pipes are coupled to each other by a surface contact.

A plasma display panel according to the present invention comprises a first polygonal plasma pipe of which fluorescent substance B is formed inside; a second polygonal plasma pipe having a smaller magnitude than the magnitude of the first polygonal plasma pipe, while a fluorescent substance different with the fluorescent substance B is formed inside of the second polygonal plasma pipe; a first electrode disposed in the perpendicular direction of the first plasma pipe and the second plasma pipe; and a second electrode disposed in the perpendicular direction of the first electrode and disposed in the horizontal direction of the second plasma pipe.

The width of the first plasma pipe is greater than the width of the second plasma pipe.

Reference will now be made in detail to embodiments of the present invention, examples of which are illustrated in the accompanying drawings.

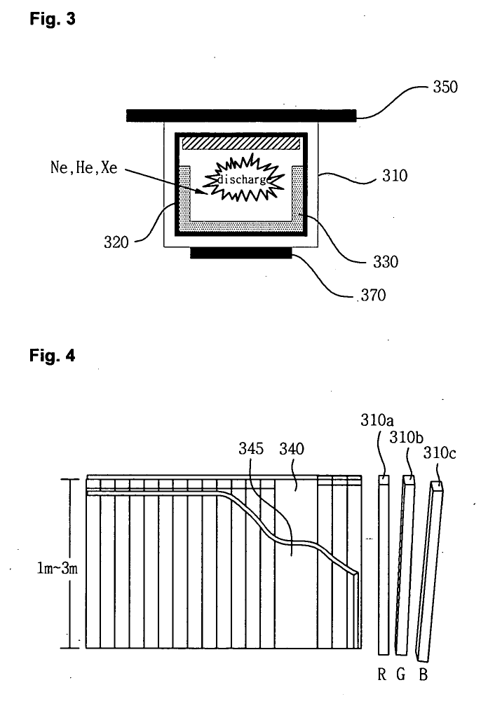

FIG. 3 represents the configuration of a plasma display panel according to the present invention. As shown in FIG. 3, the plasma display panel according to the present invention includes plasma pipe 310, a first electrode 350 and a second electrode 370.

A florescent substance 330 is formed inside of a plurality polygon plasma pipe 310. Preferably, the plasma pipe 310 has a rectangular shape. A protection layer 320 made of magnesium oxide MgO is formed on the whole inner surface of polygon plasma pipe 310 to perform discharges well. The florescent substance 330 is formed on the protection layer 320. An inert gas such as He—Xe, or He—Ne is inserted inside of the plasma pipe 310.

The first electrode 350 is disposed in the perpendicular direction of the plasma pipe 310. The first electrode 350 is sustain electrode, which is disposed in the opposite side of the florescent substance 330 formed inside of polygon plasma pipe 310.

The second electrode 370 is disposed in the perpendicular direction of the first electrode 370, disposed in parallel with the plasma pipe. The second electrode 370 is an address electrode, which is disposed in the opposite side of the first electrode 350.

R, G, B florescent substance 330 emits either a R, G, B light, when vacuum ultraviolet rays generated by the first electrode 350 that is the sustain electrode and the second electrode 370 that is the address electrode excite R, G, B florescent substance 330 surrounded by each of the plasma pipe 310.

FIG. 4 represents a plasma display panel including a plasma pipe according to the present invention. As shown in FIG. 4, plasma pipes 310a, 310b, 310c surrounding red R, green G, blue B fluorescent substance are inserted into a first panel 340 and a second panel 345 respectively. A first electrode 350 is formed on the first panel 340 and a second electrode 370 is formed on the second panel 345.

As described above, the present invention includes polygon plasma pipes 310. As shown in FIG. 3, the overlapping area between the first electrode 350, the second electrode 370 and plasma pipes 310 is increased. Accordingly, the firing voltage decreases and power consumption due to the operation of plasma display panel also decreases. As shown in FIG. 4, plasma pipes 310a, 310b, 310c are coupled to each other by a surface contact so that the connection of plasma pipes 310a, 310b, 310c is easier than with the conventional structure.

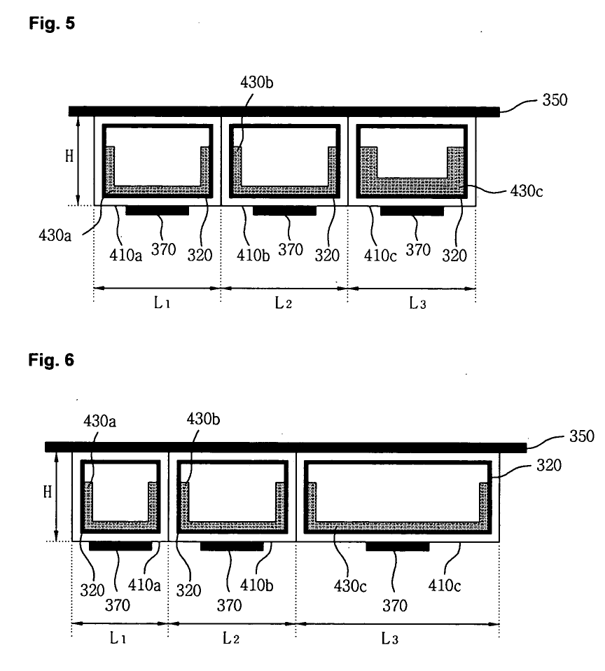

FIG. 5 represents an embodiment of a plasma pipe having a fluorescent substance of the present invention. As shown in FIG. 5, each of red R, green G, blue B fluorescent substance are formed inside of the plasma pipes 410a, 410b, 410c having the same magnitude. In other words, the width of each plasma pipe 410a, 410b, 410c is the same L1=L2=L3, the height of each plasma pipe 410a, 410b, 410c H is the same.

The amount of fluorescent substance B 430c formed inside of the plasma pipe 410c is greater than the amount of fluorescent substance R 430a and G 430b formed inside of the plasma pipes 410a, 410b respectively. Accordingly, the decrease in color temperature due to fluorescent substance B having a low light emitting efficiency is prevented.

FIG. 6 represents another embodiment of a plasma pipe having a fluorescent substance of the present invention. As shown in FIG. 6, the magnitude of a plasma pipe 410c where fluorescent substance B is formed is the largest among the plasma pipes 410a, 410b, 410c. The width L1, L2, L3 satisfy the relationship L1<L2<L3. The height H of plasma pipes are the same.

The magnitude of plasma pipe 410a where fluorescent substance R 430a is formed and the magnitude of plasma pipe 410b where fluorescent substance G 430b is formed can be the same. On the other hand, the magnitude of plasma pipe 410a where fluorescent substance R 430a is formed can be greater than the magnitude of plasma pipe 410b where fluorescent substance G 430b is formed. As described, the area where blue fluorescent substance can be coated is increased, because that the magnitude of plasma pipe 410c where fluorescent substance B 430c is formed is larger than the magnitude of other plasma pipes 410a, 410b. Accordingly, blue fluorescent substance 430c will be coated over a larger area which results in the prevention of a color temperature that is too low.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a plurality of polygonal plasma pipes having a fluorescent substance inside;
a first electrode disposed in the perpendicular direction of the plasma pipes; and
a second electrode disposed in the perpendicular direction of the first electrode and disposed in the horizontal direction of the plasma pipes.

2. The plasma display panel of claim 1, wherein the polygonal plasma pipe is a rectangular plasma pipe.

3. The plasma display panel of claim 1, wherein the plurality of polygonal plasma pipes are coupled to each other by a surface contact.

4. The plasma display panel of claim 1, wherein each of the plurality of polygonal plasma pipes has the same magnitude, wherein the amount of fluorescent substance formed in some polygonal plasma pipes among the plurality of polygonal plasma pipes is greater than the amount of fluorescent substance substance formed in the other polygonal plasma pipes.

5. The plasma display panel of claim 4, wherein the fluorescent substance formed in some polygonal plasma pipes of the plurality of polygonal plasma pipes is blue fluorescent substance.

6. The plasma display panel of claim 1, wherein some polygonal plasma pipes among the plurality of polygonal plasma pipes is larger than the other polygonal plasma pipes.

7. The plasma display panel of claim 6, wherein the amount of fluorescent substance formed inside of the some polygonal plasma pipes is greater than the amount of fluorescent substance substance formed inside of the other polygonal plasma pipes.

8. The plasma display panel of claim 7, wherein the fluorescent substance formed in the some polygonal plasma pipes is blue fluorescent substance.

9. A plasma display panel comprising:
a plurality of polygonal plasma pipes having different magnitudes according to the kind of a fluorescent substance formed inside of the plasma pipes;
a first electrode disposed in the perpendicular direction of the plasma pipes; and
a second electrode disposed in the perpendicular direction of the first electrode and disposed in the horizontal direction of the plasma pipes.

10. The plasma display panel of claim 9, wherein the width of some plasma pipes among the plurality of polygonal plasma pipes is greater than the width of the other plasma pipes.

11. The plasma display panel of claim 9, wherein some polygonal plasma pipes of which blue fluorescent substance is formed inside among the plurality of polygonal plasma pipes is larger than the other plasma pipes.

12. The plasma display panel of claim 11, wherein the width of the some plasma pipes of which blue fluorescent substance is formed inside is greater than the width of the other plasma pipes.

13. The plasma display panel of claim 9, wherein the plurality of polygonal plasma pipes are coupled to each other by a surface contact.

14. A plasma display panel comprising:
a first polygonal plasma pipe of which blue fluorescent substance is formed inside;
a second polygonal plasma pipe having a smaller magnitude than the magnitude of the first polygonal plasma pipe, while a fluorescent substance different with the fluorescent substance B is formed inside of the second polygonal plasma pipe;
a first electrode disposed in the perpendicular direction of the first plasma pipe and the second plasma pipe; and
a second electrode disposed in the perpendicular direction of the first electrode and disposed in the horizontal direction of the second plasma pipe.

15. The plasma display panel of claim 14, wherein the width of the first plasma pipe is greater than the width of the second plasma pipe.
